(19) United States
(12) Patent Application Publication
(10) Pub. No.: US 2018/0299732 A1
(43) Pub. Date: Oct. 18, 2018

(54) LIGHT SOURCE COLOR SEPERATION DEVICE AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Chenru WANG, Beijing (CN); Xue DONG, Beijing (CN); Haiwei SUN, Beijing (CN); Ruijun DONG, Beijing (CN); Lu YU, Beijing (CN); Lili CHEN, Beijing (CN)

(73) Assignees: BOE Technology Group Co., Ltd., Beijing (CN); Beijing BOE Optoelectronics Technology Co., Ltd., Beijing (CN)

(21) Appl. No.: 15/537,924

(22) PCT Filed: Sep. 14, 2016
(86) PCT No.: PCT/CN2016/098980

§ 371 Date: Jun. 20, 2017

(30) Foreign Application Priority Data
Jan. 8, 2016 (CN) 201610012580.5

(51) Int. Cl. G02F 1/1335

(52) U.S. Cl. CPC G02F 1/133615; G02B 5/1861

(57) ABSTRACT

A light source color separation device and a display device are provided. The light source color separation device includes a plurality of sawtooth units and a light-emitting unit. The plurality of sawtooth units is arranged in an array. Each of the plurality of sawtooth units includes a plurality of sawteeth, and angles between working planes and bottom planes of the sawteeth in every two adjacent sawtooth units are different. The light-emitting unit is configured to irradiate the working planes of the plurality of sawteeth with parallel light at a certain incident angle, to make the light irradiated onto and then reflected by the working planes of the sawteeth in every two adjacent sawtooth units diffracted to have different colors.

### CROSS-REFERENCE TO RELATED APPLICATION

This application claims a priority to Chinese Patent Application No. 201610012580.5 filed on Jan. 8, 2016, the disclosure of which is incorporated in its entirety by reference herein.

### TECHNICAL FIELD

The present disclosure relates to the field of display technology, and in particular to a light source color separation device and a display device.

### BACKGROUND

Along with a development of the display manufacturing technology, the liquid crystal display technology is developing rapidly, which has gradually replaced a Cathode Ray Tube (CRT) display and will become the mainstream technology of the flat-panel display in the future. In the field of liquid crystal display, the thin film transistor liquid crystal display (TFT-LCD) has been widely used in TV sets, computers, mobile phones and the like for having a large size, a high degree of integration, a powerful function, a flexible manufacturing process and a low cost, etc.

A display panel is usually made by oppositely arranging an array substrate (i.e., a TFT substrate) and a color filter substrate (i.e., a CF substrate) to form a cell and then perfusing liquid crystal molecules therein. A cell gap is maintained by a post spacer (PS), and the liquid crystal molecules are aligned through a first alignment film arranged on the color filter substrate and a second alignment film arranged on the array substrate, and a periphery region of the array substrate and the color filter substrate is sealed through a sealant.

It is found that there exist at least the following technical issues in the related art: a color filter substrate generally includes color filters of three different colors (i.e., a red filter, a green filter, a blue filter); however, these color filters need to be formed by using three different masks, which leads to a high production cost.

### SUMMARY

The present disclosure is to provide a light source color separation device and a display device capable of separating out different colors of light, so as to solve the above technical issues existing in the display device in the related art.

The present disclosure provides a light source color separation device, including: a plurality of sawtooth units arranged in an array, wherein each of the plurality of sawtooth units comprises a plurality of sawteeth, and angles between working planes and bottom planes of the sawteeth in every two adjacent sawtooth units are different; and a light-emitting unit configured to irradiate the working planes of the plurality of sawteeth with parallel light at a certain incident angle, to make the light irradiated onto and then reflected by the working planes of the sawteeth in every two adjacent sawtooth units diffracted to have different colors.

Optionally, the light-emitting unit is a collimation parallel light source.

Optionally, the light-emitting unit emits white light.

Optionally, the plurality of sawteeth is made of a metallic material capable of reflecting light.

Optionally, the plurality of sawteeth is made of aluminum.

Optionally, the plurality of sawteeth is made of quartz, the working planes of the sawteeth are provided with reflective layers which are configured to reflect the parallel light irradiated by the light-emitting unit onto the sawteeth.

Optionally, the angles between the working planes and the bottom planes of respective sawteeth in each sawtooth unit are identical.

Optionally, the plurality of sawtooth units forms an echelle grating.

Optionally, the bottom planes of the sawteeth in respective sawtooth units are located in an identical plane.

Optionally, the light-emitting unit is perpendicular to the plane.

Optionally, the collimation parallel light source is composed of light-emitting diode (LED) lights.

The present disclosure further provides a display device including the above light source color separation device.

Optionally, the display device further includes a display module arranged at a side of a light-emitting surface of the light source color separation device.

Optionally, the display module includes a plurality of pixel units arranged in an array, and the plurality of pixel units is arranged to correspond to the plurality of sawtooth units.

Optionally, the plurality of sawtooth units is arranged in a one-to-one correspondence with the plurality of pixel units in a direction perpendicular to the plane.

According to the light source color separation device in the present disclosure, the light-emitting unit irradiates the working planes of the sawteeth with parallel light at a certain incident angle. The light reflected by the working planes of the plurality of sawteeth satisfies a law of reflection. Then, the reflected light are diffracted above the working planes and dispersed. Meanwhile, by controlling sizes of the angles between the bottom planes and the working planes of the sawteeth, an intensity of the diffraction spectrum center is controlled, so as to separate out light of corresponding colors. The color separation is performed without the color filter, thereby reducing the cost and improving the productivity.

### BRIEF DESCRIPTION OF THE DRAWINGS

FIG. 1 is a schematic view showing a light source color separation device in some embodiments of the present disclosure;

FIG. 2 is a schematic view showing a display device in some embodiments of the present disclosure.

### DRAWING REFERENCE

1. sawtooth unit
2. light-emitting unit
3. pixel unit

### DETAILED DESCRIPTION

In order to help a person skilled in the art to understand the technical solution of the present disclosure better, the present disclosure will be described hereinafter in details in conjunction with the drawings and embodiments.

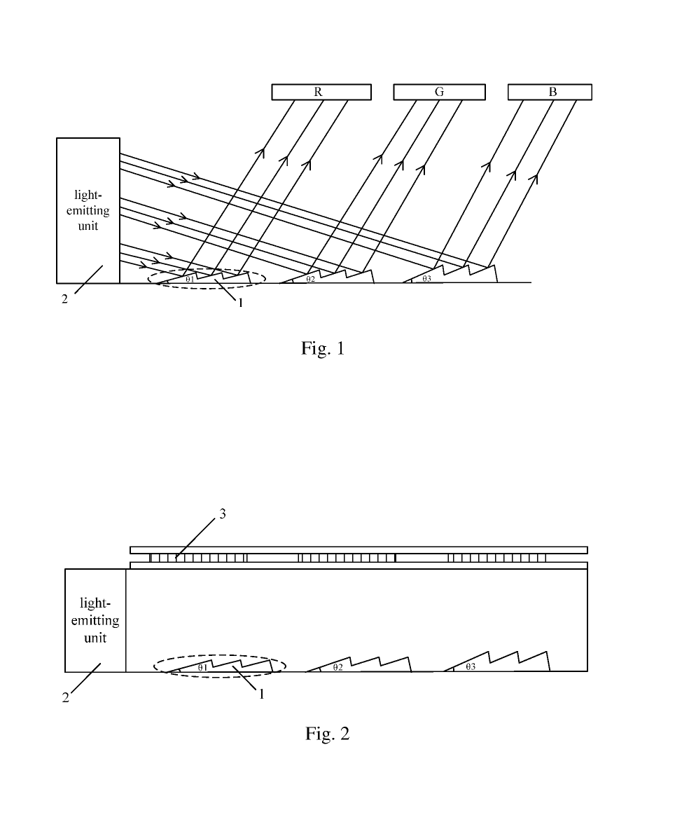

The present disclosure provides in some embodiments a light source color separation device as shown in FIG. 1, including: a plurality of sawtooth units 1 arranged in an array and a light-emitting unit 2. Each of the plurality of sawtooth units 1 includes a plurality of sawteeth, and angles between working panes and bottom planes of the sawteeth in every two adjacent sawtooth units 1 are different. The light-emitting unit 2 may irradiate the working planes of the plurality of sawteeth with parallel light at a certain incident angle, to make the light irradiated onto and then reflected by the working planes of the sawteeth in every two adjacent sawtooth units 1 diffracted to have different colors. It should be noted that, in some embodiments of the present disclosure, the sawtooth units may be arranged on a base substrate or integrated with a base substrate.

The plurality of sawtooth units 1 in some embodiments of the present disclosure forms an echelle grating (also known as reflection stepped grating) in the related art. In some embodiments of the present disclosure, due to the dispersion characteristic of the echelle grating, the light emitted by the light-emitting unit 2 and then reflected by the echelle grating are diffracted to have other colors.

Specifically, given that red, green and blue light are desired, and the light-emitting unit 2 emits white light. According to the following equation of echelle grating, mλ=2d sin θ (m is a diffraction order, λ is a wavelength, d is a grating constant, and θ is a blazing angle i.e., an angle between a working plane and a bottom plane of the sawtooth), the white light emitted by the light-emitting unit 2 may be diffracted to become light of a wavelength corresponding to the blazing angle θ. The light of the wavelength corresponds to a certain color. Those skilled in the art may know the wavelengths of red light, green light and blue light. Therefore, the sizes of the blazing angles θ corresponding to the three wavelengths respectively may be predetermined. That is, as shown in FIG. 1, the blazing angles of the sawtooth units are designed to be θ1, θ2 and θ3 respectively, and the white light reflected by the working planes of the sawteeth of a certain sawtooth unit may be diffracted to have a corresponding color. For example, the blazing angle θ1 corresponds to the red diffracted light R, the blazing angle θ2 corresponds to the green diffracted light G, and the blazing angle θ3 corresponds to the blue diffracted light B.

According to the light source color separation device in some embodiments of the present disclosure, the light-emitting unit 2 irradiates the working planes of the plurality of sawteeth with parallel light at a certain incident angle. The light reflected by the working planes of the sawteeth satisfies a law of reflection. Then, the reflected light are diffracted above the working planes and dispersed. Meanwhile, by controlling sizes of the blazing angles θ, an intensity of the diffraction spectrum center is controlled, so as to separate out light of corresponding colors. The color separation is performed without the color filter, thereby reducing the cost and improving the productivity.

The light-emitting unit 2 may be a collimation parallel light source arranged at a periphery of a region of the base substrate and the sawtooth units 1. Obviously, the collimation parallel light source may be arranged at any position, as long as the collimation parallel light source may irradiate parallel light onto the working planes of the plurality of sawteeth. In some embodiments of the present disclosure, the collimation parallel light source may be composed of light-emitting diode (LED) lights.

In some embodiments of the present disclosure, the light-emitting unit 2 emits white light. In that case, the sizes of the blazing angles of the sawtooth units 1 may be designed to correspond to red light, green light and blue light respectively, to achieve a full color display of the display device. The light emitted by the light-emitting unit 2 is not limited to white light, which may be designed as needed.

In some embodiments of the present disclosure, the sawteeth may be made of metallic aluminum or other metallic materials capable of reflecting light. Optionally, the sawteeth may be made of quartz, then the working plane of each sawtooth needs to be provided with a reflective layer to reflect the light irradiated by the light-emitting unit 2 onto the sawteeth. It should be noted that, in some embodiments of the present disclosure, the material of the sawtooth is not limited, and any material which satisfies the above condition may be used.

According to the light source color separation device in some embodiments of the present disclosure, by utilizing the color separation of the echelle grating, the light emitted by the light-emitting unit 2 may be separated into light of different colors. The light source color separation device may be applied in the display device as a backlight source, such that the color filter is not required, thereby reducing the cost and improving the productivity.

The present disclosure provides in some embodiments a display device as shown in FIG. 2 including the above light source color separation device. Therefore, the color filter is not required in the display device, thereby reducing the cost and improving the productivity.

In some embodiments of the present disclosure, the display device further includes a display module arranged at a side of a light-emitting surface of the light source color separation device. The display module includes a plurality of pixel units 3 arranged in an array, and the pixel units 3 are arranged to correspond to the plurality of sawtooth units 1, thereby realizing the full color display of the display device.

In some embodiments of the present disclosure, the display module of the display device may include an array substrate and an opposite substrate, that is, the color filter is not required. Optionally, the opposite substrate may be replaced by a color filter substrate, then a chroma of the display device may be increased and display effect may be improved.

The display device may be a liquid crystal display device or an electroluminescent display device, for example, any product or component with a display function, such as liquid crystal panel, electronic paper, mobile phone, tablet PC, TV set, display, notebook computer, digital photo frame and navigator.

The above are merely the exemplary embodiments of the present disclosure and shall not be used to limit the scope of the present disclosure. It should be noted that, a person skilled in the art may make improvements and modifications without departing from the principle of the present disclosure, and these improvements and modifications shall also fall within the scope of the present disclosure.

1. light source color separation device, comprising:
a plurality of sawtooth units arranged in an array, wherein each of the plurality of sawtooth units comprises a plurality of sawteeth, and angles between working planes and bottom planes of the sawteeth in every two adjacent sawtooth units are different; and
a light-emitting unit configured to irradiate the working planes of the plurality of sawteeth with parallel light at a certain incident angle, to make the light irradiated onto and then reflected by the working planes of the sawteeth in every two adjacent sawtooth units diffracted to have different colors.

2. The light source color separation device according to claim 1, wherein the light-emitting unit is a collimation parallel light source.

3. The light source color separation device according to claim 1, wherein the light-emitting unit emits white light.

4. The light source color separation device according to claim 1, wherein the plurality of sawteeth is made of a metallic material capable of reflecting light.

5. The light source color separation device according to claim 4, wherein the plurality of sawteeth is made of aluminum.

6. The light source color separation device according to claim 1, wherein the plurality of sawteeth is made of quartz, the working planes of the sawteeth are provided with reflective layers which are configured to reflect the parallel light irradiated by the light-emitting unit onto the sawteeth.

7. The light source color separation device according to claim 1, wherein the angles between the working planes and the bottom planes of respective sawteeth in each sawtooth unit are identical.

8. The light source color separation device according to claim 1, wherein the plurality of sawtooth units forms an echelle grating.

9. The light source color separation device according to claim 1, wherein the bottom planes of the sawteeth in respective sawtooth units are located in an identical plane.

10. The light source color separation device according to claim 9, wherein the light-emitting unit is perpendicular to the plane.

11. The light source color separation device according to claim 2, wherein the collimation parallel light source is composed of light-emitting diode (LED) lights.

12. A display device comprising the light source color separation device according to claim 1.

13. The display device according to claim 12, further comprising a display module arranged at a side of a light-emitting surface of the light source color separation device.

14. The display device according to claim 13, wherein the display module comprises a plurality of pixel units arranged in an array, and the plurality of pixel units is arranged to correspond to the plurality of sawtooth units.

15. The display device according to claim 13, wherein the plurality of sawtooth units is arranged in a one-to-one correspondence with the plurality of pixel units in a direction perpendicular to the plane.

16. The light source color separation device according to claim 2, wherein the light-emitting unit emits white light.
